(19) United States
(12) Patent Application Publication
(10) Pub. No.: US 2021/0135329 A1
(43) Pub. Date: May 6, 2021

(54) IMPLEMENTATION OF INDUCTIVE POSTS IN AN SIW STRUCTURE AND PRODUCTION OF A GENERIC FILTER

(71) Applicants: UNIVERSITÉ DE BORDEAUX, Bordeaux (FR); INSTITUT POLYTECHNIQUE DE BORDEAUX, Talence (FR); CENTRE NATIONAL DE LA RECHERCHE SCIENTIFIQUE, Paris (FR); CENTRE NATIONAL D'ETUDES SPATIALES, Paris (FR)

(72) Inventors: Anthony GHIOTTO, Begles (FR); Frédéric PARMENT, Ramonville-St-Agne (FR)

(73) Assignees: UNIVERSITÉ DE BORDEAUX, Bordeaux (FR); INSTITUT POLYTECHNIQUE DE BORDEAUX, Talence (FR); CENTRE NATIONAL DE LA RECHERCHE SCIENTIFIQUE, Paris (FR); CENTRE NATIONAL D'ETUDES SPATIALES, Paris (FR)

(21) Appl. No.: 16/617,038

(22) PCT Filed: Jun. 1, 2018
(86) PCT No.: PCT/EP2018/064505

§ 371 Date: Nov. 26, 2019

(30) Foreign Application Priority Data
Jun. 2, 2017 (FR) 1754929

(51) Int. Cl. H01P 1/208; H01P 1/17; G01N 27/20

(52) U.S. Cl. CPC H01P 1/2088; G01N 27/205; H01P 1/173

(57) ABSTRACT

A microwave component (10) of the type substrate integrated transmission line, comprises at least one upper layer (14) having at least one electrically conductive surface (26), a lower layer (16) having at least one electrically conductive surface (44), and a central layer (18) defining a propagation area (20) of an electromagnetic wave extending along a propagation axis.

The upper layer (14) comprises at least an upper hole (30) passing through it; the lower layer (16) comprises at least one lower hole (46) passing through it. An electrically conductive wire (22) is received through the upper hole (30), the propagation area (20) and the lower hole (46), the conductive wire (22) being electrically connected to the electrically conductive surface (26) of the upper layer (14) and the electrically conductive surface (44) of the lower layer (16).

### CROSS REFERENCE TO RELATED APPLICATIONS

This application is a U.S. national stage application under 35 U.S.C. § 371 of International Application No. PCT/EP2018/064505, filed Jun. 1, 2018 which claims priority to French patent application no. 1754929, filed Jun. 2, 2017, the entireties of which are incorporated herein by reference.

The present invention relates to a microwave component of the type substrate integrated transmission line type, including a wave guide comprising at least one upper layer having at least one electrically conductive surface, a lower layer having at least one electrically conductive surface, and a central layer defining a propagation area for an electromagnetic wave, the propagation area extending along a propagation axis.

It is known to use SIW technology (this acronym meaning “substrate integrated waveguide”) for the design of microwave transmission lines. Such components are commonly referred to using the expression “SIW components”.

Such SIW components are made from layers of substrates commonly used in the electronics field, which makes the manufacture of such SIW components inexpensive.

Furthermore, such SIW components generally have a light structure, and generally do not require shielding, while allowing a high integration density.

Thus, such SIW components constitute a serious alternative to the usual waveguides, such as 3D metallic waveguides, which generally do not have such advantages, and printed circuit boards, which do not perform as well as is necessary today for certain applications, particularly for applications at millimetric frequencies (30 GHz to 300 GHz).

These SIW components are therefore not fully satisfactory.

Indeed, the production of such components requires many steps and makes it possible to obtain a component only able to fulfill the role of a single function and to satisfy a single application.

The current solutions thus require manufacturing different components each time one changes the function of the latter. Certain recent solutions make it possible to change the response without manufacturing a new component owing to different control methods. For example, it is possible to use ferrite or active elements such as diodes, transistors or mechanical actuators. However, their cost is often higher and the control of these elements is very complex to establish.

One object of the invention is therefore to provide a simple microwave component making it possible to perform a filtering function of an electromagnetic wave and to satisfy several applications.

To that end, the invention relates to a microwave component of the aforementioned type, wherein the upper layer comprises at least one upper hole passing through it, the lower layer comprises at least one lower hole passing through it, and in that an electrically conductive wire is received through the upper hole, the propagation area and said lower hole, the conductive wire being electrically connected to the electrically conductive surface of the upper layer and the electrically conductive surface of the lower layer.

The microwave component according to the invention may comprise one or more of the following features, considered alone or according to any technically possible combination(s):
the propagation area comprises a cavity, the cavity being delimited by the upper layer, the lower layer and the central layer, the upper hole and the lower hole emerging in the cavity, the conductive wire passing through the cavity;
the upper layer comprises a plurality of upper traversing holes, and the lower layer comprises a plurality of lower traversing holes, a plurality of electrically conductive wires each respectively being received through one of said upper holes, the propagation area and one of said lower holes, each conductive wire being electrically connected to the electrically conductive surface of the upper layer and the electrically conductive surface of the lower layer;
the set of upper holes receiving a conductive wire has a distribution having at least one plane of symmetry;
at least one of said lower holes and at least one of said upper holes do not receive a conductive wire and are arranged facing one another;
an electrically conductive concealing member covers at least one lower hole and/or at least one upper hole in which no conductive wire is received;
the conductive concealing member is an electrically conductive adhesive tape or an electrically conductive plate;
at least some of the upper holes are distributed on the upper layer so as to form a regular grid;
for each conductive wire, the upper hole and the lower hole receiving said conductive wire are arranged facing one another;
at least one of the upper layer, the lower layer and the central layer comprises an electrically conductive upper sublayer, an electrically conductive lower sublayer and a dielectric central sublayer, inserted between the upper sublayer and the lower sublayer;
the waveguide is capable of guiding an electromagnetic wave having a wavelength greater than or equal to a predetermined minimum wavelength, each upper and lower hole having, projected respectively over the electrically conductive surface of the upper layer and over the electrically conductive surface of the lower layer, a larger dimension strictly smaller than the predetermined minimum wavelength, in particular smaller than one fifth of the predetermined minimum wavelength, preferably smaller than one tenth of the predetermined minimum wavelength;
each conductive wire is fastened to the upper layer and the lower layer, in particular by welding; and
each lower hole and each upper hole has edges comprising an electrically conductive coating.

The invention also relates to a method for adjusting a microwave component comprising the following steps:
supplying a microwave component of the type substrate integrated transmission line, including a wave guide comprising at least one upper layer having an electrically conductive surface, a lower layer having an electrically conductive surface, and a central layer defining a propagation area for an electromagnetic wave, the propagation area extending along a propagation axis, the upper layer delimiting one or several upper traversing hole(s), and the lower layer delimiting one or several lower traversing hole(s);
supplying at least one electrically conductive wire;
installing said or each wire, the installation step comprising, for each wire:
inserting the conductive wire through said or one of said lower hole(s), the propagation area and said or one of said upper hole(s); and
electrically connecting the conductive wire to the electrically conductive surface of the upper layer and the electrically conductive surface of the lower layer.

The adjusting method can comprise the following optional feature: the upper layer comprises a plurality of upper traversing holes, and the lower layer comprises a plurality of lower traversing holes, the method comprising supplying at least a plurality of electrically conductive wires; the method further comprising a step for determining a set of lower holes and a set of upper holes in which to insert said conductive wires, such that the waveguide has a predetermined transfer function, each upper hole of the set of upper holes being associated with a lower hole of the set of lower holes;

the installation of each conductive wire comprising:
inserting the conductive wire through one of the lower holes of the set of lower holes, the propagation area and the associated upper hole of the set of upper holes; and
electrically connecting the conductive wire to the electrically conductive surface of the upper layer and the electrically conductive surface of the lower layer.

The invention will be better understood upon reading the following description, provided solely as an example, and in reference to the appended drawings, in which:

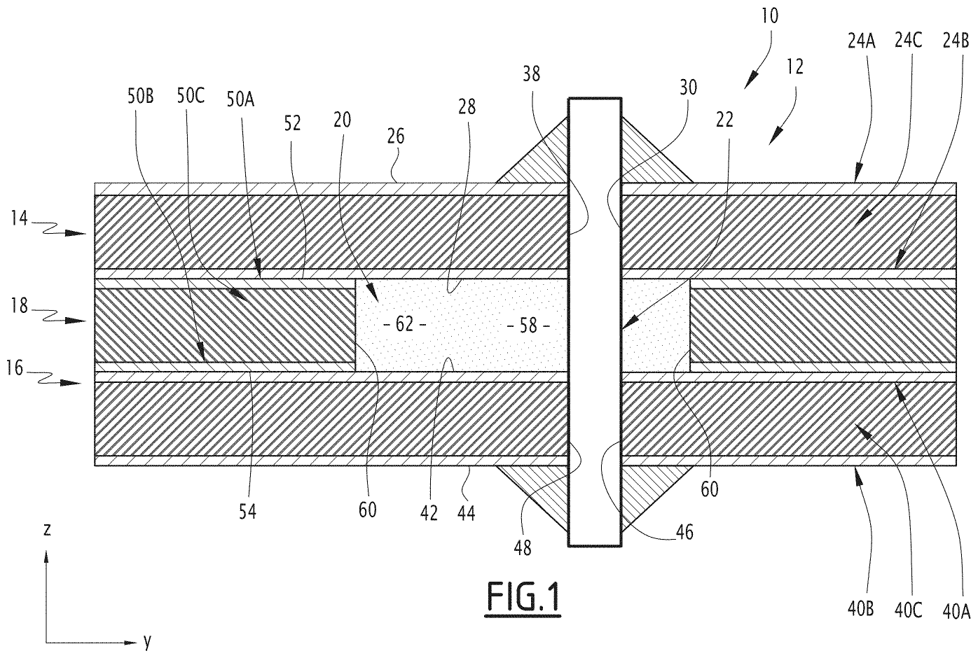

FIG. 1 is a sectional schematic view orthogonal to the propagation axis of a first embodiment of a component according to the invention;

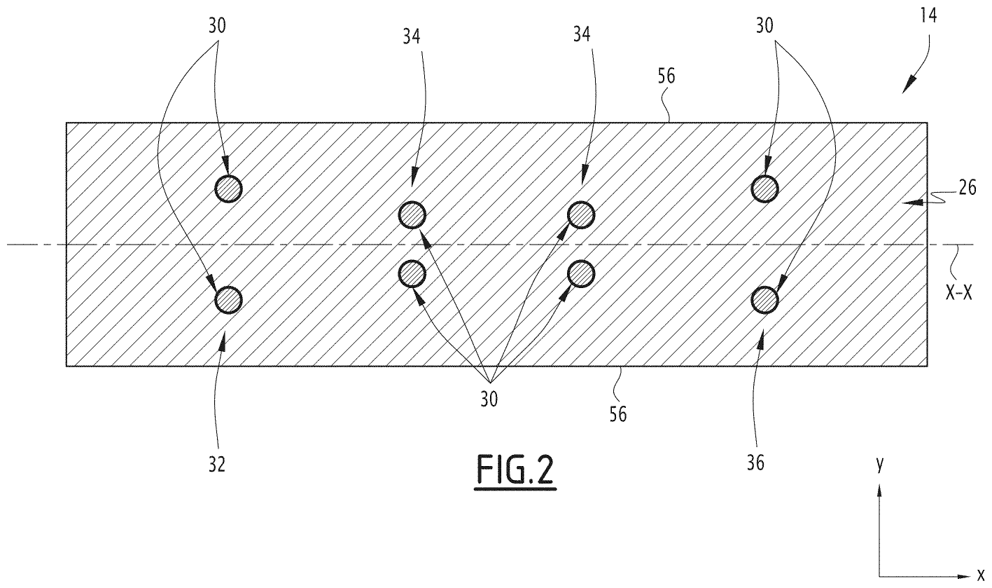

FIG. 2 is a schematic top view of the component of FIG. 2;

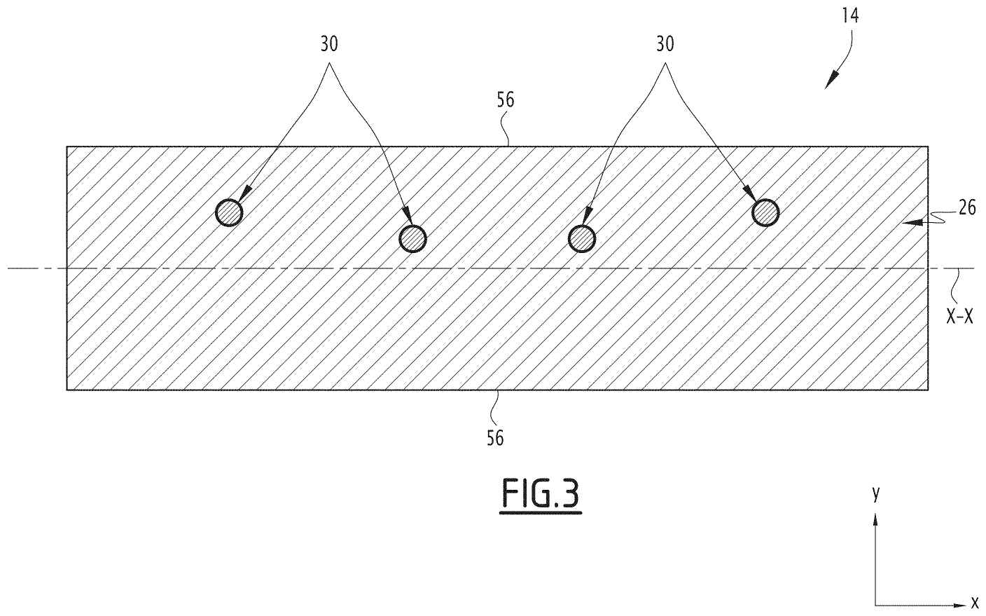

FIGS. 3 to 5 are schematic top views similar to that of FIG. 2 of other embodiments of components according to the invention.

A first embodiment of a microwave component 10 according to the invention is illustrated in FIGS. 1 and 2.

The microwave component 10 is for example a filter, in particular a bandpass, low-pass, high-pass or notch filter. In a variant, the microwave component 10 is for example a multiplexer, a coupler, a divider, a combiner, an antenna, an oscillator, an amplifier, a charge, a circulator or an isolator.

The microwave component 10 here is of the type “with substrate integrated guide”.

The component 10 includes a waveguide 12 capable of guiding an electromagnetic wave along a propagation axis X-X, the electromagnetic wave having a wavelength greater than or equal to a predetermined minimum wavelength.

The waveguide 12 comprises an upper layer 14, a lower layer 16, and a central layer 18 defining a propagation zone 20 of the electromagnetic wave, extending along the propagation axis X-X.

The waveguide 12 further comprises a plurality of electrically conductive wires 22 passing through the propagation zone 20, as described hereinafter.

The upper layer 14 extends along a plane XY, defined by the propagation axis X-X and by a transverse axis Y-Y orthogonal to the propagation axis X-X. Hereinafter, “transverse direction” will refer to a direction parallel to the transverse axis Y-Y.

In a preferred embodiment, the upper layer 14 comprises an electrically conductive upper sublayer 24A, an electrically conductive lower sublayer 24B and a dielectric central sublayer 24C, inserted between the upper sublayer 24A and the lower sublayer 24B.

The upper layer 14 thus forms a substrate.

Hereinafter, “electrically conductive element” means that said element has an electrical conductivity greater than 1*10⁶ S·m⁻¹, preferably equivalent to that of a metal of the copper, silver or aluminum type.

Hereinafter, “dielectric element” means that said element has a relative dielectric permittivity greater than or equal to 1.

The upper sublayer 24A and the lower sublayer 24B are for example made from copper. The transfer sublayer 24C is for example made from epoxy resin, or Teflon.

The upper layer 14 thus has an electrically conductive upper surface 26 and an electrically conductive lower surface 28.

The upper layer 14 comprises at least one upper traversing hole 30.

Each upper hole 30 emerges in the propagation zone 20.

Each upper hole 30 passes through the upper sublayer 24A, the lower sublayer 24B and the dielectric central sublayer 24C of the upper layer 14.

Each upper hole 30 has, projected on the upper surface 26 of the upper layer 14, a maximum dimension strictly smaller than the predetermined minimum wavelength, in particular smaller than one fifth of the predetermined minimum wavelength, preferably smaller than one tenth of the predetermined minimum wavelength. Losses by radiation are thus avoided.

Each upper hole 30 here has a cylinder shape of revolution, with a circular section.

Each upper hole 30 preferably has edges 38 comprising an electrically conductive coating. The upper sublayer 24A and the lower sublayer 24B of the upper layer 14 are then electrically connected. In a variant, the edges 38 are devoid of such an electrically conductive coating.

In the example illustrated in FIG. 2, the upper layer 14 comprises a plurality of upper traversing holes 30, in particular eight upper traversing holes 30. In a variant, it has any number of upper traversing holes 30.

The upper holes 30 are distributed along the propagation axis X-X by pairs of two, the two upper holes 30 of a same pair being aligned along the transverse direction Y-Y.

The upper layer 14 thus has, successively along the axis X-X, an input pair 32, two intermediate pairs 34 and an output pair 36.

The distance along the transverse direction Y-Y between the two upper holes 30 of the intermediate pairs 34 is substantially identical. The respective distances along the transverse direction Y-Y between the two upper holes 30 of the input pair 32 and the output pair 36 are substantially identical.

The set of upper holes 30 has a distribution having two planes of symmetry orthogonal to the upper surface 26 of the upper layer 14.

One of said planes of symmetry is parallel to the propagation axis X-X and the other of said planes of symmetry is parallel to the transverse axis Y-Y.

The lower layer 16 extends along the plane XY.

In the embodiment illustrated in FIGS. 1 and 2, the lower layer 16 comprises an electrically conductive upper sublayer 40A, an electrically conductive lower sublayer 40B and a dielectric central sublayer 40C, inserted between the upper sublayer 40A and the lower sublayer 40B.

The lower layer 16 thus forms a substrate.

The lower layer 16 thus has an electrically conductive upper surface 42 and an electrically conductive lower surface 44.

The lower layer 16 comprises at least one lower traversing hole 46.

Each lower traversing hole 46 emerges in the propagation zone 20.

Each lower traversing hole 46 passes through the upper sublayer 40A, the lower sublayer 40B and the dielectric central sublayer 40C of the lower layer 16.

Each lower hole 46 has, projected on the lower surface 44 of the lower layer 16, a maximum dimension strictly smaller than the predetermined minimum wavelength, in particular smaller than one fifth of the predetermined minimum wavelength, preferably smaller than one tenth of the predetermined minimum wavelength.

Each lower hole 46 here has a cylinder shape of revolution, with a circular section.

Each lower hole 46 preferably has edges 48 comprising an electrically conductive coating. The upper sublayer 40A and the lower sublayer 40B of the lower layer 16 are then electrically connected. In a variant, the edges 48 are devoid of such an electrically conductive coating.

Each lower hole 46 is arranged facing one of the upper holes 30 along a direction Z-Z orthogonal to the propagation axis X-X and the transverse axis Y-Y.

In the example illustrated in FIG. 2, the number of lower holes 46 is equal to the number of upper holes 30.

The central layer 18 extends along the plane XY.

In the embodiment illustrated in FIGS. 1 and 2, the central layer 18 comprises an electrically conductive upper sublayer 50A, an electrically conductive lower sublayer 50B and a dielectric central sublayer 50C, inserted between the upper sublayer 50A and the lower sublayer 50B.

The central layer 18 thus forms a substrate.

The central sublayer 50C of the central layer 18 has a first relative dielectric permittivity.

The central layer 18 thus has an electrically conductive upper surface 52 and an electrically conductive lower surface 54.

As illustrated in FIG. 1, the upper layer 14 and the lower layer 16 are arranged at a distance from one another, on either side of the central layer 18, in contact with the central layer 18.

In particular, the lower surface 28 of the upper layer 14 is in contact with the upper surface 52 of the central layer 18. Likewise, the lower surface 54 of the central layer 18 is in contact with the upper surface 42 of the lower layer 16.

Thus, the upper layer 14, the lower layer 16 and the central layer 18 form a stack.

Furthermore, the lower sublayer 24B of the upper layer 14 is electrically connected with the upper sublayer 50A of the central layer 18. Likewise, the lower sublayer 50B of the central layer 18 is electrically connected with the upper sublayer 40A of the lower layer 16.

The propagation area 20 corresponds to an area in which the electromagnetic wave is combined during its propagation in the waveguide 12.

The propagation area 20 is delimited by the lower surface 28 of the upper layer 14, the upper surface 42 of the lower layer 16 and two side borders 56 spaced apart from one another (see FIG. 2).

As illustrated in FIG. 1, the propagation area 20 comprises a cavity 58.

The lateral borders 56 of the propagation area 20 are able to prevent the passage of an electromagnetic wave having a wavelength greater than or equal to the minimum predetermined wavelength.

The side borders 56 extend parallel to the propagation axis X-X and here are parallel to one another.

The side borders 56 are in particular arranged on either side of the cavity 58, for example outside the cavity 58.

According to one embodiment, at least one of the side borders 56 comprises a row of electrically conductive vias, arranged at least through the central cavity 18. A “via” refers to a hole, arranged at least through the central layer 18, having walls covered with an electrically conductive coating, for example metallized.

More specifically, each via extends along the direction Z-Z orthogonal to the propagation axis X-X and through the transverse axis Y-Y, while passing through at least the central layer 18.

According to one embodiment, each via is arranged through the central layer 18, the upper layer 14 and the lower layer 16.

Each via electrically connects the upper layer 14 and the lower layer 16 to one another.

The separation between two successive vias of a side border is smaller than the predetermined minimum wavelength, in particular smaller than one tenth of the predetermined minimum wavelength, preferably smaller than one twentieth of the predetermined minimum wavelength.

In a variant, or additionally, at least one of the side borders 56 of the symmetrical chamber comprises an electrically conductive plate.

The cavity 58 of the propagation zone 20 is delimited by the upper layer 14, the lower layer 16 and the central layer 18. More specifically, the cavity 58 is delimited by the lower surface 28 of the upper layer 14, the upper surface 42 of the lower layer 16 and side edges 60 of the central layer 18.

The side edges 60 of the central layer 18 are substantially rectilinear and parallel relative to one another and relative to the propagation axis X-X.

The side edges 60 extend orthogonally to the lower surface 28 of the upper layer 14 and the upper surface 42 of the lower layer 16.

The side edges 60 are advantageously covered by an additional dielectric layer, not shown. In a variant, the side edges 60 could be metallized, that is to say, covered by an electrical conductor.

The cavity 58 is filled with a fluid 62 having a second relative dielectric permittivity lower than or equal to the first relative dielectric permittivity.

The fluid 62 is for example air. In a variant, in the case where the cavity 58 defines a sealed closed volume, it is filled with air, nitrogen or is empty of fluid 62.

Each upper hole 30 and each lower hole 46 emerges in the cavity 58.

Each electrically conductive wire 22 is respectively received through one of said upper holes 30, the propagation area 20 and one of said lower holes 46 arranged facing the upper hole 30.

Each conductive wire 22 in particular passes through the cavity 58 of the propagation area 20.

Each conductive wire 22 is electrically connected to the upper surface 26 of the upper layer 14 and the lower surface 44 of the lower layer 16.

Each conductive wire 22 is for example made from silver or is covered with a silver coating.

Each conductive wire 22 is fastened to the upper layer 14 and the lower layer 16, in particular by welding. In a variant, each conductive wire 22 is fastened to the upper layer 14 and to the lower layer 16 such that it is flush with the upper surface 26 of the upper layer 14 and with the lower surface 44 of the lower layer 16.

Advantageously, the conductive wires 22 are pre-strained. They then extend rectilinearly, along the axis Z-Z orthogonal to the propagation axis X-X and the transverse axis Y-Y.

In the example illustrated in FIG. 2, each upper hole 30 and each lower hole 46 receives a conductive wire 22. In FIG. 2, the inside of the upper holes 30 receiving a conductive wire 22 is crosshatched.

The presence of a conductive wire 22 in the propagation area 20 causes a local variation in the geometry of the propagation area 20, and therefore a variation in the properties of the waveguide 12, for example a variation in the response of the waveguide 12.

Furthermore, each conductive wire 22 constitutes an obstacle along the journey of an electromagnetic wave propagating in the propagation area 20, which results in modifying the electromagnetic wave at the output, relative to the electromagnetic wave at the output obtained in the absence of the conductive wire 22.

The arrangement and the number of upper 30 and lower 46 holes receiving a conductive wire 22 are determined so that the waveguide 12 has a predetermined transfer function.

A method for adjusting a microwave component 10 according to the first embodiment will now be described.

The method comprises supplying the microwave component 10 described above, in which none of the upper 30 and lower 46 holes receive the electrically conductive wire.

The method next comprises supplying an electrically conductive wire 22 and installing said conductive wire 22.

The installation of the conductive wire 22 comprises inserting it through one of said lower holes 46, the propagation area 20 and one of said upper holes 30 arranged across from said lower hole 46.

The conductive wire 22 is next electrically connected with the upper surface 26 of the upper layer 14 and the lower surface 44 of the lower layer 16.

A second embodiment of a component according to the invention is illustrated in FIG. 3.

This second embodiment differs from the first embodiment of FIG. 2 in that the set of upper holes 30 has a distribution with no plane of symmetry parallel to the propagation axis X-X and orthogonal to the upper surface 26 of the upper layer 14 and the lower surface 44 of the lower layer 16.

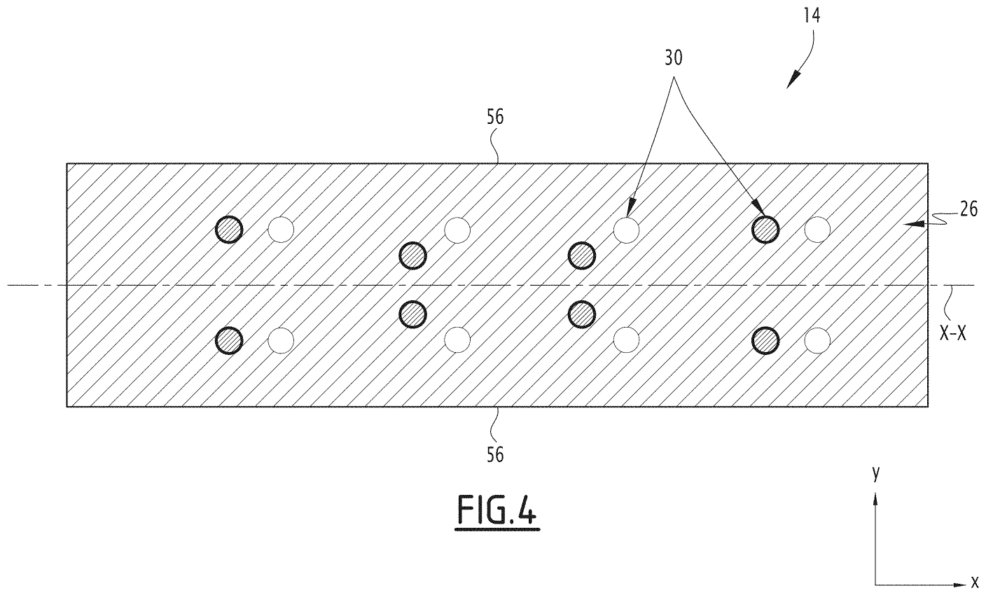

A third embodiment of a component according to the invention is illustrated in FIG. 4.

This third embodiment differs from the embodiments of FIGS. 2 and 3 in that one or a plurality of lower holes 46 and a plurality of upper holes 30 do not receive a conductive wire.

The numbers of lower and upper holes not receiving a conductive wire are equal.

Each upper hole not receiving a conductive wire is arranged facing a lower hole not receiving a conductive wire.

In FIG. 4, the inside of the upper holes 30 receiving a conductive wire 22 is crosshatched and the inside of the upper holes 30 not receiving a conductive wire is white.

The waveguide 12 then advantageously comprises an electrically conductive concealing member, not shown, covering at least one lower hole or upper hole in which no conductive wire is received.

The conductive concealing member is attached on the upper surface 26 of the upper layer 14 or on the lower surface 44 of the lower layer 16.

The conductive concealing member is for example an electrically conductive adhesive tape or an electrically conductive plate.

A method for adjusting the microwave component 10 according to the third embodiment will now be described.

The method differs from the method for adjusting the component according to the first embodiment described above in that it further comprises supplying at least a plurality of other electrically conductive wires 22.

The method includes determining a set of lower holes 46 and a set of upper holes 30 in which said conductive wires 22 are inserted, such that the waveguide 12 has a predetermined transfer function, each upper hole 30 of the set of upper holes 30 being associated with a lower hole 46 of the set of lower holes 46 arranged facing the upper hole 30.

The installation of each conductive wire 22 comprises its insertion through one of the lower holes 46 of the set of lower holes 46, the propagation area 20 and the associated upper hole 30 of the set of upper holes 30, and its electrical connection with the upper surface 26 of the upper layer 14 and the lower surface 44 of the lower layer 16.

The waveguide thus has the predetermined transfer function.

At least one of said lower holes 46 and at least one of said upper holes 30 do not receive a conductive wire.

The method then comprises supplying one or a plurality of concealing members and covering one or plurality of upper and lower holes not receiving a conductive wire through one of the concealing members.

When an operator wishes for the waveguide 12 previously adjusted to have a second predetermined transfer function, the method comprises reconfiguring the waveguide 12.

The reconfiguration of the waveguide 12 then comprises a second step for determining upper 30 and lower 46 holes in which to insert the conductive wires 22, such that the waveguide 12 has the second predetermined transfer function.

The reconfiguration next comprises a step for removing the conductive wires 22 received in the upper 30 and lower 46 holes.

In the case where, before the removal step, a conductive wire 22 is already received in an upper hole 30 and a lower hole 46 determined in the second determining step, then the conductive wire 30 is advantageously not removed during the removal step. For each upper 30 and lower 46 hole determined in the second determining step, one of the conductive wires 22 is inserted through said determined lower hole 46, the propagation area 20 and said determined upper hole 30, and electrically connected with the upper surface 26 of the upper layer 14 and the lower surface 44 of the lower layer 16.

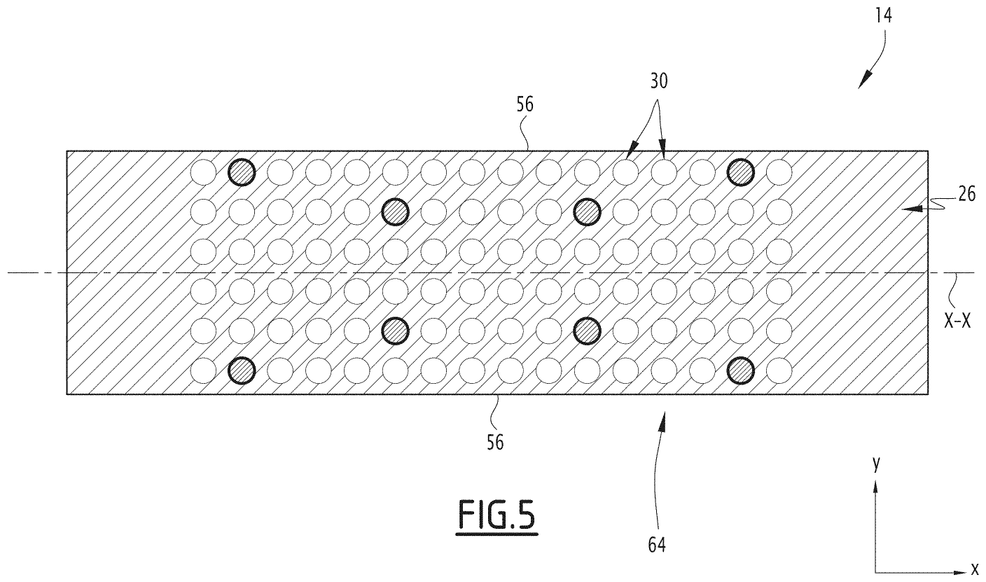

A fourth embodiment of a component according to the invention is illustrated in FIG. 5.

This fourth embodiment differs from the third embodiment of FIG. 4 in that at least some of the upper holes 30 are distributed on the upper layer 14 so as to form a regular grid 64.

In particular, all of the upper holes 30 are advantageously distributed to form the regular grid 64.

Likewise, all of the lower holes 46 are advantageously distributed to form the regular grid 64, while being arranged facing the upper holes 30.

“Regular grid” means that these upper 30 or lower 46 holes are distributed in a regular mesh grid periodically repeating on the upper layer 14 or on the lower layer 16, respectively.

In the example illustrated in FIG. 5, the regular grid 64 is a mesh.

Like in the third embodiment of FIG. 4, a plurality of lower holes 46 and a plurality of upper holes 30 do not receive a conductive wire. In FIG. 5, the inside of the upper holes 30 receiving a conductive wire 22 is crosshatched and the inside of the upper holes 30 not receiving a conductive wire is white.

Such a waveguide 12 allows easy configuration of a plurality of predetermined transfer functions of the waveguide 12.

In a variant of the preceding embodiments, the upper layer 14 and/or the lower layer 16 is (are) formed by an integral monobloc layer, electrically conductive, for example made from metal.

In another variant of the preceding embodiments, the upper layer 14, the lower layer 16 and the central layer 18 form a substrate.

The upper layer 14 and the lower layer 16 are then each a single electrically conductive integral layer, and the central layer 18 is a single dielectric integral layer.

In still another variant of the preceding embodiments, the upper layer 14 and the lower layer 16 respectively have a single upper and lower traversing hole emerging in the propagation area 20, in particular emerging in the cavity 58.

In this variant, the component 10 has an impedance adaptation function to another circuit or T divider.

Owing to the features described above, the component is very easy to manufacture and makes it possible to perform a filtering function for a very competitive cost, with a method that makes it possible to reuse a device while facilitating the interconnection with planar circuits.

Furthermore, the conductive wires 22 can be implemented to perform an impedance adaptation to another circuit.

The component has a fast design time, and can be reconfigured to perform another function.

1. A microwave component of the type substrate integrated transmission line, including a wave guide comprising at least one upper layer having at least one electrically conductive surface, a lower layer having at least one electrically conductive surface, and a central layer defining a propagation area for an electromagnetic wave, the propagation area extending along a propagation axis,
wherein the upper layer comprises at least one upper traversing hole, the lower layer comprises at least one lower traversing hole,
and in that an electrically conductive wire is received through the upper hole the propagation area and said lower hole, the conductive wire being electrically connected to the electrically conductive surface of the upper layer and the electrically conductive surface of the lower layer,
the propagation area comprising a cavity, the cavity being delimited by the upper layer, the lower layer and the central layer,
the upper hole and the lower hole emerging in the cavity, the conductive wire passing through the cavity.

2. The microwave component according to claim 1, wherein the upper layer comprises a plurality of upper traversing holes, and the lower layer comprises a plurality of lower traversing holes, a plurality of electrically conductive wires each respectively being received through one of said upper holes, the propagation area and one of said lower holes, each conductive wire being electrically connected to the electrically conductive surface of the upper layer and the electrically conductive surface of the lower layer.

3. The microwave component according to claim 2, wherein the set of upper holes receiving a conductive wire has a distribution having at least one plane of symmetry.

4. The microwave component according to claim 2, wherein at least one of said lower holes and at least one of said upper holes do not receive a conductive wire and are arranged facing one another.

5. The microwave component according to claim 4, wherein an electrically conductive concealing member covers at least one lower hole and/or at least one upper hole in which no conductive wire is received.

6. The microwave component according to claim 5, wherein the conductive concealing member is an electrically conductive adhesive tape or an electrically conductive plate.

7. The microwave component according to claim 2, wherein at least some of the upper holes are distributed on the upper layer so as to form a regular grid.

8. The microwave component according to claim 1, wherein for each conductive wire, the upper hole and the lower hole receiving said conductive wire are arranged facing one another.

9. The microwave component according to claim 1, wherein at least one of the upper layer, the lower layer and the central layer comprises an electrically conductive upper sublayer, an electrically conductive lower sublayer and a dielectric central sublayer, inserted between the upper sublayer and the lower sublayer.

10. A The microwave component according to claim 1, wherein the waveguide is capable of guiding an electromagnetic wave having a wavelength greater than or equal to a predetermined minimum wavelength,
each upper and lower hole having, projected respectively over the electrically conductive surface of the upper layer and over the electrically conductive surface of the lower layer, a larger dimension strictly smaller than the predetermined minimum wavelength.

11. The microwave component according to claim 10, wherein each each upper and lower hole have, projected respectively over the electrically conductive surface of the upper layer and over the electrically conductive surface of the lower layer, a lamer dimension smaller than one fifth of the predetermined minimum wavelength.

12. The microwave component according to claim 11, wherein each upper and lower hole have, projected respectively over the electrically conductive surface of the upper layer and over the electrically conductive surface of the lower layer, a larger dimension smaller than one tenth of the predetermined minimum wavelength.

13. (canceled)

14. (canceled)

15. The microwave component according to claim 1, wherein each conductive wire is fastened to the upper layer and the lower layer.

16. The microwave component according to claim 15, wherein each conductive wire is fastened to the upper layer and the lower layer by welding.

17. The microwave component according to claim 1, wherein each lower hole and each upper hole have edges comprising an electrically conductive coating.

18. A method for adjusting a microwave component comprising:
providing a microwave component of the type substrate integrated transmission line, including a wave guide comprising an upper layer having an electrically conductive surface, a lower layer having at least one electrically conductive surface, and a central layer defining a propagation area for an electromagnetic wave, the propagation area extending along a propagation axis,
the upper layer delimiting one or several upper traversing hole(s), and the lower layer delimiting one or several lower traversing hole(s);
supplying at least one electrically conductive wire;
installing said or each wire, this installing comprising, for each wire:
inserting the conductive wire through said or one of said lower hole(s), the propagation area and said or one of said upper hole(s); and
electrically connecting the conductive wire to the electrically conductive surface of the upper layer and the electrically conductive surface of the lower layer.

19. The method for adjusting a microwave component according to claim 18, wherein the upper layer comprises a plurality of upper traversing holes, and the lower layer comprises a plurality of lower traversing holes, the method comprising supplying at least a plurality of electrically conductive wires;
the method further comprising determining a set of lower holes and a set of upper holes in which to insert said conductive wires, such that the waveguide has a predetermined transfer function, each upper hole of the set of upper holes being associated with a lower hole of the set of lower holes;
wherein installing each conductive wire comprises:
inserting the conductive wire through one of the lower holes of the set of lower holes, the propagation area and the associated upper hole of the set of upper holes; and
electrically connecting the conductive wire to the electrically conductive surface of the upper layer and the electrically conductive surface of the lower layer.
